(19) United States
(12) Patent Application Publication
(10) Pub. No.: US 2020/0070180 A1
(43) Pub. Date: Mar. 5, 2020

(54) BLOW GUN

(71) Applicant: SILVENT AB, Boras (SE)

(72) Inventor: Rasmus TIBELL, Billdal (SE)

(21) Appl. No.: 16/490,458

(22) PCT Filed: Mar. 2, 2018
(86) PCT No.: PCT/SE2018/050202

§ 371 Date: Aug. 30, 2019

(30) Foreign Application Priority Data
Mar. 2, 2017 (SE) 1750224-6

(51) Int. Cl. B05B 1/00; B05B 12/00; B05B 1/30

(52) U.S. Cl. CPC B05B 1/005; B05B 1/3026; B05B 12/002

(57) ABSTRACT

A compressed air blow gun comprises a valve having a spool (41) movable in a cylinder (203). The spool (41) has two piston heads (411, 413) spaced from each other along a piston rod (412). The pressurized air is fed to a space (414) between the two piston heads (411, 413), whereby the spool (41) is pressure balanced, and a trigger (40) is connected to the spool (41) for moving it in the cylinder (203) unaffected by the force from the pressurized air. Upon pulling the trigger (40), the spool (41) moves to uncover an outlet (211′) to permit the air to pass to a nozzle (33). The blow gun brings about an improved working environment, e.g. by reducing the risk of causing a repetitive strain injury. In preferred embodiments, the spool (41) and the trigger (40) are an integral unit (4), the spool (41) and the cylinder (203) are curved, the number of components is reduced, the assembling is facilitated, the nozzle (30) is a silenced nozzle, and a filtering anti backflow valve (5) is provided in an air inlet passage (201) to the blow gun.

### FIELD OF INVENTION

The present invention relates to a blow gun for controllably directing a stream of a high-pressure medium by actuation of an internal medium valve, including:
a) a gun body having an inlet passage adapted for connection to a source of pressurized medium;
b) a valve chamber communicating with said inlet passage, said valve chamber defining a cylinder;
c) a spool accommodated in said cylinder, said cylinder and said spool together forming said internal medium valve;
d) an outlet passage having an outlet nozzle with a nozzle passage for directing said medium stream, said outlet passage communicating with said valve chamber; and
e) a pivotal trigger lever mounted in the gun body and connected to the spool to permit an operator to displace the spool in the cylinder to activate and deactivate said internal medium valve.

### BACKGROUND OF THE INVENTION

Blow guns for blowing a highly pressurized medium, especially air, are widely known. Blow guns fed with pressurized air are used everywhere in industry, and then primarily for blowing dirt and foreign particles from surfaces and interior chambers of machines. Environmental requirements and requirements for good ergonomics increase all the time. On the work environment frontier, a reduced noise level and reduced energy consumption are constantly recurrent requirements. As far as ergonomics is concerned, repetitive strain injuries are a growing sector.

The greater part of the blow guns of today have a design that cannot satisfy reasonable requirements for a good working environment. A majority of the guns are not designed to reduce the noise level. As far as ergonomics is concerned, when the compression increases, also the force required for controlling the blow intensity of the gun increases. A high gripping force for controlling the blow intensity may cause a repetitive strain injury to occur as a result of a monotonous grip during an extended period of time. In blow guns of the type disclosed in U.S. Pat. No. 3,880,355 (Larson et al.) the full force of the pressurized air supplied to the gun has to be overcome by an operator when pressing in the trigger pin to start the blowing.

The blow guns generally comprise many components, which increases the probability of a reduced life time. Simultaneously, a multitude of components (vide GB 1 599 330 A, for example) makes the assembling of the gun more complicated. Another example is disclosed in U.S. Pat. No. 9,511,380 B2 (Tiberghien et al.) where the trigger is a two-armed pivotal lever. On pushing in one end of the trigger, the other end swings out permitting the supplied pressurized air to push aside a piston having a beveled end from its sealing contact with a beveled end of a sleeve, through which the supplied pressurized air flows. The risk of causing a repetitive strain injury is reduced, but the multitude of components makes the assembling of the gun more complicated.

CN 203610373 U discloses a blow gun having a valve comprising a cylinder with a wide portion and a narrow portion and a spool axially moveable in the cylinder and having a wide spool portion, which matches the diameter of the wide cylinder portion, and a narrow spool portion, which matches the diameter of the narrow cylinder portion. Between the wide spool portion and the narrow spool portion the spool has a middle portion with a reduced diameter defining with the cylinder wall a tubular space, to which the pressurized air is supplied. The free end of the narrow spool portion, has the shape of a tapered plug that cooperates with an internally tapered seal ring provided in a transition between the wide portion and the narrow portion of the cylinder. A helical spring surrounds the middle portion of the spool and has one end supported by the wide portion of the spool, while the other end presses a disk spring against the beveled sealing ring. Upon pushing in the trigger, the spool moves axially in the cylinder and the tapered plug is lifted from its sealing contact with the tapered sealing ring to let pressurized air pass through the valve and be blown out from the blow gun. Thus, every time the operator starts the blowing by pushing the trigger, he has to overcome the combined pressure from the pressurized air and the spring. In course of time, this may cause repetitive strain injuries.

Due to their design, a large majority of the blow guns contribute to the existence of poor working environments, and they generally have a high power consumption. If the feed pressure of the pressurized air is increased, a blow gun of conventional design will require an increased finger pressure on the trigger to open the valve and start the blowing operation.

Further, the force on the trigger also increases proportionally with the pressure area of the opening component of the valve. To achieve an increased blow intensity, the amount of air through the blow gun has to be increased. This is done by increasing the through flow area. Then, the valve area has to be increased proportionally. As the trigger force increases proportionally to the square of the valve diameter, the force rapidly becomes unmanageably high.

### SUMMARY OF THE INVENTION

The object of the present invention is to provide an efficient blow gun that can bring about an improved working environment.

This object is achieved in that in accordance with a first embodiment of the invention the spool in the blow gun specified in the first paragraph above includes a first piston head located at a start of the outlet passage, a piston rod extending from the first piston head to the pivotal lever, and a second piston head spaced from the first one along the piston rod by a tubular space communicating with the inlet passage, and the two piston heads being balanced, i.e. being of the same diameter and/or working area.

Hereby, the pressurized air supplied to the blow gun will enter into the tubular space between the two piston heads and will act on them with equal forces in opposite directions. The momentary pressure of the pressurized air will have no effect on the force required of an operator for pulling the trigger, and the risk of causing a repetitive strain injury is markedly reduced.

This new valve design includes fewer components than prior art valves and thereby simplifies the assembly of the blow gun. In a preferred embodiment, the pivotal trigger lever and the spool are made as an integral unit, and the gun body and the pivotal trigger lever and the spool are preferably made from a material permitting snap mounting of the integral unit in the gun body. Thereby the assembling of the blow gun is considerably facilitated, since the spool and the snap members may be deformed temporarily without getting damaged or permanently deformed.

A suitable material for the gun body and the pivotal trigger lever and the spool is a fiber, preferably glass fibre, reinforced polymer, for example nylon 66 resin (poly(hexamethylene adipamide)). This material is extremely tough, resilient and has a very good shape-memory i.e. it returns to its original shape after being temporarily deformed.

Preferably, the valve chamber cylinder and the spool are curved, which facilitates the assembling of the blow gun. The valve chamber cylinder and the spool suitably curve in the direction of the medium flow from the inlet passage to the nozzle. Such a design makes it possible to let the direction of flow deviate less than 90° upon passing from the inlet passage into the valve chamber cylinder and also to deviate less than 90° upon passing from the valve chamber cylinder into the outlet passage. By using deviations of less than 90°, pressure losses are reduced and a higher efficiency is obtained. Conventional blow guns usually have two 90° deviations. Such a curved piston rod means that if the spool is exposed to a medium at a pressure which dangerously above the safe working pressure then the spool will tend to straighten out which will break the seal against the inside of the valve chamber cylinder. This will allow the medium to leak out. Once the pressure of the medium has been reduced to a safe level the spool will return to its original shape and again form a seal against the inside of the valve chamber cylinder.

Preferably the outlet passage starts as an opening in the wall of the valve chamber, and there it suitably has a cross section of a shape, for example a tapered cross section which starts narrowly and gets progressively wider towards the upper end of the valve chamber, that will result in a progressive flow of the high-pressure medium upon progressive movement of the spool to open the valve progressively. Thereby, in the beginning of the opening movement of the spool, the opening area will increase successively, so that a gradual increase of the blowing force is obtained. At the end of the opening movement, the outlet area from the valve may be radically increased, which results in a booster effect on the blow force and makes it reach its maximum level.

To achieve the progressive flow in a simple way, the outlet passage at its start preferably has a wide longitudinal groove-shaped recess for progressively receiving the high-pressure medium upon an opening of the valve.

To contribute to an improved working environment. the nozzle preferably is a silenced blowing nozzle comprising a central part with at least one central Laval nozzle having a discharge opening that will generate a concentrated core stream with supersonic velocity, and further a more peripheral part surrounding the central part and comprising a plurality of secondary nozzles having a plurality of secondary nozzle openings spaced from one another and the at least one discharge opening, each secondary nozzle opening generating a stream that is divergent from the axis of the core stream. By the divergent direction of the peripheral gas stream the concentration of the central beam becomes more accentuated in comparison with peripheral gas streams that are parallel to the core stream. A more concentrated core stream results in lower energy consumption, since a concentrated stream results in a better blowing precision. This leads to shorter blowing time and thus less energy consumption. The invented blowing nozzle also decreases the turbulence, which means a lower noise level and an improved working environment. Thereby less energy gets wasted in sound generation which leads to a higher blowing force. A higher blowing force in relation to the gas consumption means that the efficiency of the nozzle is increased.

It is preferred that at least some of said secondary nozzles are Laval nozzles, preferably all of them. This further contributes to attain a core stream that is as concentrated as possible. The Laval nozzles allow the peripheral streams to have supersonic speed, although lower than the supersonic speed of the core stream. This further decreases turbulence, and thereby leads to a lower sound level and an improved working environment. Preferably all of them are Laval nozzles since it provides an optimal effect in this respect.

It is also preferred that an anti-backflow valve is located in the inlet passage. The anti-backflow valve improves the working environment by reducing noise caused by the pressurized medium upon entering the inlet passage and minimizing the explosive noise which otherwise occurs upon disconnection of a blow gun from a pressurized medium source.

The anti-backflow valve preferably includes a generally thimble-shaped valve body made of an elastic plastic material and having a plurality of laterally extending slits permitting axial compression and extension of the valve body, said valve body sealing against a seat of a nipple connector in the blow gun upon disconnection of a fast coupling between the blow gun and the pressurized air source.

It is preferred that the elastic plastic material is a thermoplastic polyurethane ester resin that has a good shape memory and is resistant to oil.

Preferably, the slits of the valve body also are shaped to serve as a filter to prevent possible unwanted particles in the medium from reaching and blocking the nozzle.

In addition, it is preferred that the valve body, even when fully compressed, permits a full medium flow through the blow gun.

### BRIEF DESCRIPTION OF THE DRAWINGS

In the following, the invention will be described in more detail with reference to preferred embodiments and the appended drawings.

FIG. 1 is a longitudinal sectional view of a preferred embodiment of the blow gun of the present invention.

FIG. 2 is an exploded isometric view of the blow gun of FIG. 1 with a portion of the gun wall cut away to show the interior of the gun.

FIG. 3 is an isometric view of an integral unit including a pivotal trigger lever and a valve spool.

FIG. 4 shows a portion of FIG. 1 on a larger scale.

FIG. 5 is a cross sectional view taken along line V-V in FIG. 4 but modified to show the valve spool in a position where the valve is slightly open.

FIG. 6 is a longitudinal sectional view along the axis of an exemplary blowing nozzle for use in blow gun of the invention.

FIG. 7 illustrates the shape of the core stream of the blowing nozzle of FIG. 6.

FIG. 8 is an isometric view of a generally thimble-shaped valve body having a plurality of laterally extending slits.

FIG. 9 is a longitudinal sectional view of the valve body of FIG. 8 mounted in a nipple having a seat for forming an anti-backflow valve.

### MODE(S) FOR CARRYING OUT THE INVENTION

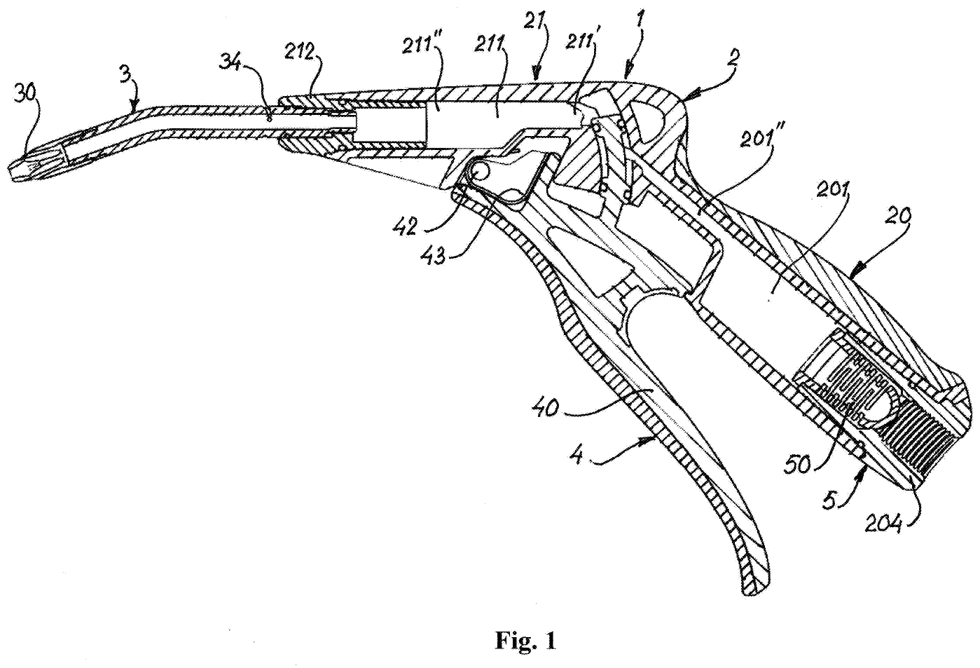

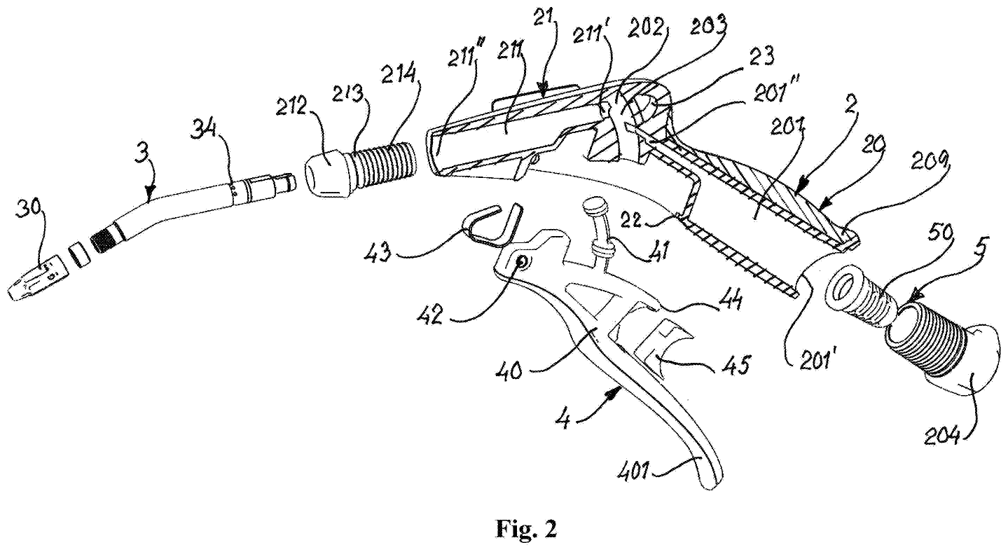

The drawings show a preferred embodiment of a blow gun for controllably directing a stream of a high-pressure medium, usually air, by actuation of an internal medium valve 1. The blow gun includes a gun body 2 and a pivotal trigger lever 4 mounted in the gun body 2 and connected to the internal medium valve 1. As is best shown in FIG. 2, the gun body 2 includes a through conduit for the high-pressure medium and has a handle 20 with an inlet passage 201 and a fore end 21 with an outlet passage 211. In the preferred embodiment shown in the drawings, the handle 20 and the fore end 21 usually form an acute angle with each other, preferably about 35°. In the preferred embodiment shown in FIGS. 1 and 2, the blow gun has a hang up eye 23 for hanging up the blow gun in a suspending block installation, not shown.

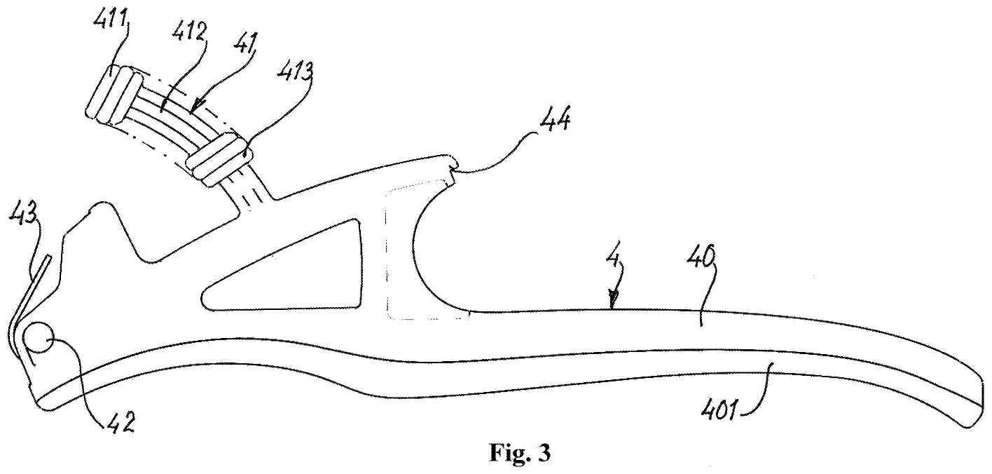

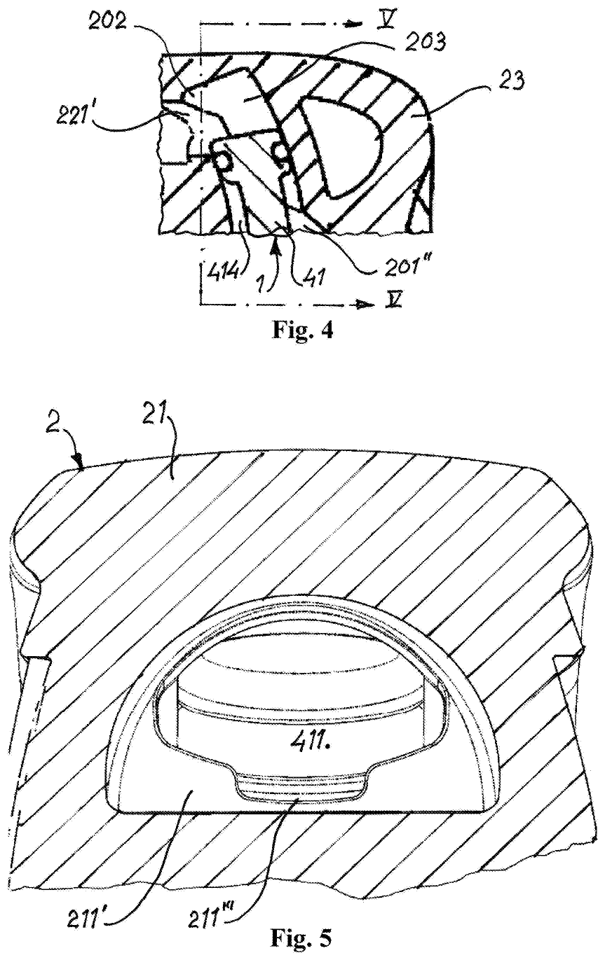

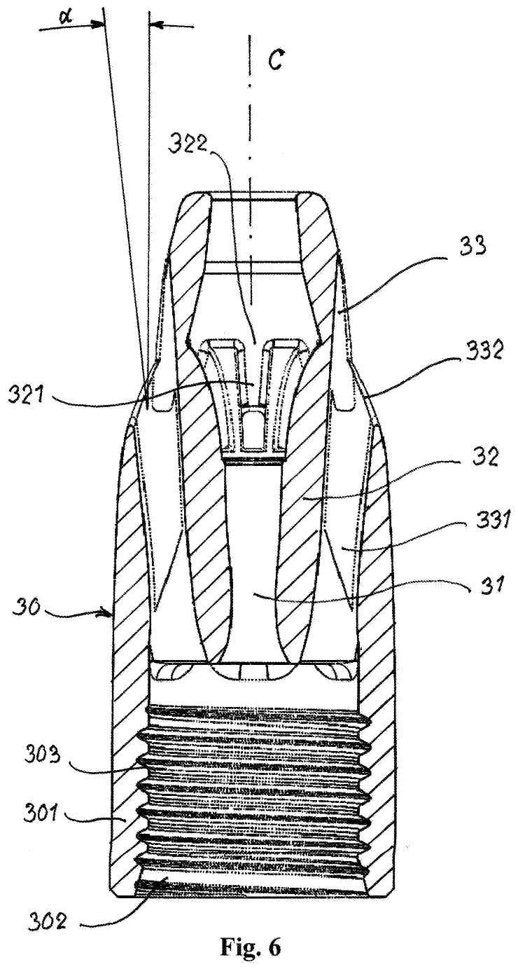

As best shown in FIG. 1, on its way from the inlet passage 201 to the outlet passage 211 the high-pressure medium passes the valve 1. The valve 1 includes a valve chamber 202 communicating with the inlet passage 201 and defining a cylinder 203. The inlet passage 201 has a large entrance 201′ for the high-pressure medium and a smaller outlet 201″ to the valve chamber 202. The valve 1 also includes a spool 41 accommodated in the cylinder 203. The spool 41 is best shown in FIG. 3. The fore end 21 includes an outlet passage 211 communicating with the valve chamber 202 and having an outlet nozzle 30 with a nozzle passage 31 for directing the medium stream. The nozzle 30 will be described in connection with FIG. 6 below. The outlet passage 211 has a comparatively small entrance 211′ from the wall of the valve chamber 202 which can have a upwardly tapered cross-section which starts narrow and gets wider to provide a progressive flow. The outlet passage can have a larger downstream portion 211″ up to the position of a fitting 212 inserted in the end of the fore end 21. The outlet nozzle 30 is mounted in one end of a blowing pipe 3, the other end of which is inserted in the fitting 212. If desired, the blowing pipe 3 along its length may be provided with at least one side discharge 34 for forming a shield of high-pressure medium to protect the operator from blow of rejection particles. Such a side discharge 34 is preferably located at a short distance from the fitting 212. Further, the design satisfies the OSHA requirement in that the side discharge 34 or other venting design prevents pressure exceeding 30 PSI if tip of the nozzle 30 becomes blocked.

A pivotal trigger lever 40 best shown in FIG. 3 is mounted in the gun body 2 and connected to the spool 41 to permit an operator to displace the spool 41 in the cylinder 203 to activate and deactivate said internal medium valve 1.

To provide an efficient blow gun that can bring about an improved working environment in accordance with the present invention, the spool 41 includes a first piston head 411 located at a start of the outlet passage 211, a piston rod 412 extending from the first piston head 411 to the pivotal trigger lever 40, and a second piston head 413 spaced from the first one along the piston rod 412 by a annular tubular space 414 communicating with the inlet passage 201, and the two piston heads 411, 413 being of the same diameter. The piston heads are provided with conventional sealing rings for sealing against the wall of the cylinder 203.

In this way, the pressurized air supplied to the blow gun will enter into the annular tubular space 414 between the two piston heads 411, 413 of equal diameters and will act on them with equal forces in opposite directions, thereby neutralizing the effect of pressure and valve area. The momentary pressure of the high-pressure medium will have no effect on the force required of an operator for pulling the trigger 40, and the risk of causing a repetitive strain injury is markedly reduced.

This new design of the valve 1 includes fewer components than prior art valves and thereby simplifies the assembly of the blow gun. In a preferred embodiment, the pivotal trigger lever 40 and the spool 41 are made as an integral unit 4, and the gun body 2, the pivotal trigger lever 40 and the spool 41 are made from a material permitting snap mounting of the integral unit 4 in the gun body 2. Thereby the assembling of the blow gun is considerably facilitated, since the spool 41 and the snap members (i.e. a snap member 44 provided on the integral unit 4 and a matching snap member 22 in the gun body handle 20 best shown in FIGS. 3 and 2, respectively) may be deformed temporarily without getting damaged or permanently deformed. On mounting of the integral unit 4 in the gun body 2, snap member 22 will pass into the gun body 2 and be located behind snap member 44, which then will retain the integral unit 4 in the gun body 2. The material to be used to permit snap mounting of the integral unit 4 in the gun body 2 preferably is a glass fiber reinforced nylon 66 resin (poly(hexamethylene adipamide)). Two such resins are marketed by DuPont under the trade name Zytel® ST801 and Zytel® HTN. Of course, other materials having similar properties may be used, if desired.

A shaft member 42 for the pivotal movement of the trigger lever 40 is best shown in FIG. 3, which also shows a spring 43 for maintaining the pivotal trigger lever 40 in an outer position, where the valve 1 is closed. The spring preferably is a leaf spring 43. On pulling the pivotal trigger lever 40 inward toward the gun handle 20, the valve 1 opens to permit the high-pressure medium to pass from the inlet passage 201 through the valve chamber 202 into the outlet passage 211. The described design of the valve 1 makes the valve pressure balanced, so that upon pulling the pivotal trigger lever 40, the only resistance felt by an operator is the force from the spring 43. The possibly varying pressure of the high-pressure medium gives no effect on the pivotal trigger lever 40.

The most frequently used method of storing the blow gun when not in use is to hang it up on a suitable support (not shown). The blow gun has a space formed between the pivotal trigger 40 and the gun body 20, and that makes it possible to hang the blow gun on the support. To increase the life of the blowgun 20, it is preferred to provide a member 45, shown in FIG. 2, for wear protection of the surfaces of the blow gun that contact the support. The wear protection member 45 may be attached to the integral unit 4 by snap mounting, for example, and may be made of metal.

To facilitate the assembling of the blow gun, the valve chamber cylinder 203 and the spool 41 suitably are curved. Preferably, they are curved in the direction of the high-pressure medium flow from the inlet passage 201 to the nozzle 30. As is best shown in FIG. 1. Such a design gives the advantage that the medium flow through the blow gun will not be exposed to two deflections of 90°, which is usual in traditional blow guns, but will be deflected an angel of less than 90° both when passing from the inlet passage 201 into the valve chamber 202 and from the valve chamber 202 into the outlet passage 211. Thereby pressure losses are considerably reduced and a higher efficiency of the valve and the blow gun are achieved.

The outlet passage 211 starts at the valve chamber 202, and there it suitably has a cross section of a shape that will result in a progressive flow of the high-pressure medium upon progressive movement of the spool 41 to open the valve 1 progressively. Thereby, in the beginning of the opening movement of the spool 41, the opening area will increase successively, so that a gradual increase of the blowing force is obtained. At the end of the opening movement, the outlet area from the valve 1 is radically increased, which results in a booster effect on the blow force and makes it reach its maximum level. As shown in FIG. 5, to achieve the progressive flow in a simple way, the outlet passage 211 at its start preferably has a wide longitudinal groove-shaped recess 211″′ for progressively receiving the high-pressure medium upon an opening of the valve 1.

To contribute to an improved working environment. the nozzle preferably is a silenced blowing nozzle 30 shown in FIG. 6. Such a nozzle is disclosed in the Swedish patent application No. 1650842-6 for “A Silenced Blowing Nozzle and a Method for its Manufacture” filed on Jun. 15, 2015, the disclosure of which hereby is incorporated in its entirety in the present application. The blowing nozzle 30 has a main housing 301 with an inlet 302 for a high-pressure medium such as air, for example. The main housing 301 has an internal thread 303 adjacent the inlet 302 for connection to the blowing pipe 3.

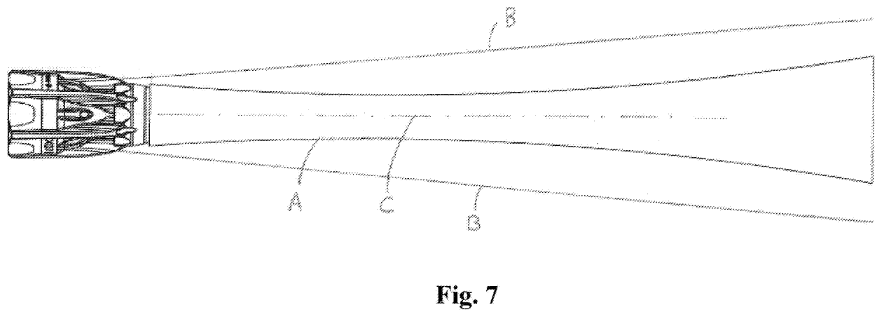

The nozzle 30, which suitably is manufactured by 3-D printing, is arranged to generate a core stream with a centre axis C and comprises a central part 32 with at least one Laval nozzle 321 having a discharge opening 322 that will generate a concentrated core stream A (shown in FIG. 7) with supersonic velocity. It is to be understood that the core stream alternatively could be generated by a plurality of Laval nozzles.

The nozzle 30 further comprises a more peripheral part 33 surrounding the central part 32 and comprising a plurality of secondary nozzles 331 having secondary nozzle openings 332 spaced from one another and the at least one central discharge opening 322. Each secondary nozzle opening generates a stream that has a direction that is divergent from the axis C of the core stream. The direction forms an angle α with the axis C. In the illustrated example the angle α is 4.75°, but it can be in the range of 1° to 8°, preferably in the range of 2.5° to 5°. Suitably, at least some of the secondary nozzles 331 are Laval nozzles, preferably all of them. Of course, other multichannel nozzles may be used, if desired.

By the divergent direction of the peripheral stream of high-pressure medium, the concentration of the central beam becomes more accentuated in comparison with peripheral streams that are parallel to the core stream. A more concentrated core stream than the one produced by prior art nozzles results in lower energy consumption, since a concentrated stream results in a better blowing precision. This leads to shorter blowing time and thus less energy consumption. The blowing nozzle of FIG. 6 also reduces the turbulence, which means that a lower noise level and an improved working environment is achieved. Thereby, less energy will be wasted in sound generation, which results in the advantage of a higher blowing force. A higher blowing force in relation to the consumption of the high-pressure medium means that the efficiency of the nozzle is increased. FIG. 7 in a side view illustrates the shape of the core stream A obtained with the blowing nozzle of FIG. 6. The core stream of a blowing nozzle according to prior art is indicated as B. As can be seen, the core stream from the blowing nozzle of FIG. 6 is much more concentrated.

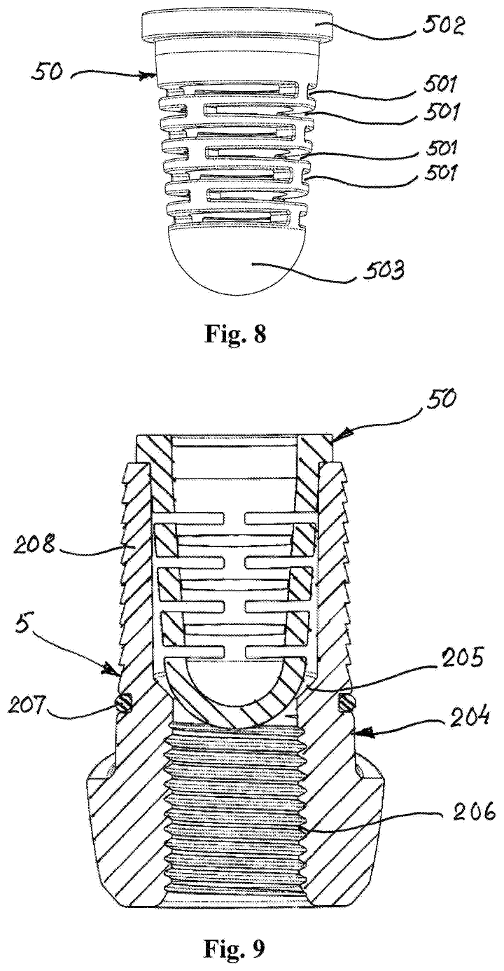

In the preferred embodiment shown in FIG. 1, an anti-backflow valve 5 is located in the inlet passage 201 of the handle 20. The anti-backflow valve 5 improves the working environment by reducing noise caused by the pressurized medium upon entering the inlet passage 201 and minimizing an explosive noise upon disconnection of the blow gun from the pressurized medium source. The components of a preferred embodiment of the anti backflow valve 5 are best shown in FIGS. 8 and 9.

There, the anti-backflow valve 5 includes a generally cup-shaped or thimble-shaped valve body 50 made of an elastic plastic material such as a thermoplastic polyurethane (TPU) and having a plurality of laterally extending through slits 501 permitting axial compression and extension of the valve body 50, which at one end has a flange 502 while the other end 503 is closed. The laterally extending slits 501 are arranged in pairs on opposite sides of the valve body 50, and each pair is rotated 90° in relation to an adjacent pair.

The anti-backflow valve 5 further includes a fitting 204 inserted in the inlet passage 201 of the blow gun and having a seat 205 for the closed end 503 of the valve body 50. The fitting 204 further comprises an internal thread 206 for connection of the blow gun to the source of high-pressure medium, an O-ring 207 for sealing against an inner cylindrical wall of the inlet passage 201, and a barbed portion 208 having circumferential ridges facing backward, making insertion of the fitting 204 into the inlet passage 201 easy and removal difficult. The barbs engage the material of the gun body 2.

The fitting 212 that is inserted in the fore end 21 if the gun body 2 is made of the same material as the fitting 204 and has likewise an O-ring 207 for sealing against an inner cylindrical wall of the outlet passage 211, and a barbed portion 208 having circumferential ridges facing backward, making insertion of the fitting 212 into the outlet passage 211 easy and removal difficult.

Upon connection of the blow gun to the source of high-pressure medium, the valve body 50 is compressed axially to let the medium pass through the slits 501. The choice of material, the dimensioning and the positioning are decisive for the functioning, the properties, and for avoiding jarring sounds caused by vibrations. Also when the blow gun delivers a maximum flow, the high-pressure medium will be able to pass through the slits 501, which thanks to their crosswise alternating orientation will be flattened at their center to block medium flow but remain open at their ends to permit the high-pressure medium to pass. Upon disconnection of a fast coupling (not shown) between the blow gun and the source of high-pressure medium, the valve body 50 will expand longitudinally and make the closed end 503 seal against the seat 205.

Preferably, the slits 501 of the valve body 50 also are shaped to serve as a filter for removing possible unwanted particles in the medium to reach and block the nozzle. The size of the slits 501 is dependent on the dimensioning diameters of the passages in the nozzle 30.

It is preferred that the elastic plastic material is a thermoplastic polyurethane ester resin that has a good shape memory and is resistant to oil. Such a material is marketed by Covestro AG in Leverkusen, Germany, under the trade name Desmopan 460. Of course, another material having similar properties may be used, if desired.

As shown in FIG. 1. the handle 20 and the pivotal trigger 40 are suitably provided with a soft grip 209 for the heel of an operator's hand and 401 for the back side of the four fingers that can be folded in over the palm. The material used for the soft grips 209 and 401 suitably is a thermoplastic elastomer, sometimes referred to as thermoplastic rubber, and preferably both the handle 20 and the pivotal trigger 40 with the soft grips 209 and 401, respectively, are formed by 2-component molding, where the two materials fuse together in the interface between them by forming what may be called a chemical bond. Suitably, the soft grip material has a Shore hardness of about 60. An example of such a material is dryflex® 861005—available from Elasto Sweden AB The soft grip contributes in bringing about an improved working environment.

The materials in the blow gun are selected with regard to how tough the blow guns are handled in industry and the fact that a blow gun is a “risk product” by being exposed to internal pressure. Should it burst, it might hurt the operator. The selection of materials in combination with the inventive unique design gives a very strong and safe product. In addition, the product will normally never crack or lose parts irrespective of how high a pressure it is exposed to. Thanks to the design, at extreme system pressures, the curved valve chamber and spool will straighten and allow the high-pressure medium to pass through and be discharged. Then, the pressure is reduced, the parts return to their original working shapes and positions and the blow gun is ready to work again.

The present invention has been shown and described herein in what is considered to be the most practical and preferred embodiment. It is recognized, however, that departures may be made therefrom within the scope of the invention and that obvious modifications will occur to a person skilled in the art. As an example, although preferred materials are mentioned in the description, other materials having substantially the same properties may be used, and also other multichannel nozzles than nozzle 30 may be used.

### INDUSTRIAL APPLICABILITY

The blow gun of the present application is fed with a high-pressure medium and is useful in a large number of applications in industry, and then primarily for blowing dirt and foreign particles from surfaces and interior chambers of machines. It is especially useful where an improved working environment is desired.

1. A blow gun for controllably directing a stream of a high-pressure medium by actuation of an internal medium valve (1), including:
a) a gun body (2) having an inlet passage (201) adapted for connection to a source of pressurized medium;
b) a valve chamber (202) communicating with said inlet passage (201), said valve chamber (202) defining a cylinder (203) with an outlet end;
a spool (41) accommodated in said cylinder (203), said cylinder (203) and said spool (41) together forming said internal medium valve (1);
d) an outlet passage (211) having an outlet nozzle (30) with a nozzle passage (31) for directing said medium stream, said outlet passage (211) communicating with said outlet end of said valve chamber (202);
e) a pivotal trigger lever (40) mounted in the gun body (2) and connected to the spool (41) to permit an operator to displace the spool (41) in the cylinder (203) to activate and deactivate said internal medium valve (1);
f) the spool (41) including a first piston head (411) a piston rod (412) extending from the first piston head (411) to the pivotal lever (40), and a second piston head (413) spaced from the first one (411) along the piston rod (412) by an annular tubular space (414) communicating with the inlet passage (201) and able to be brought into communication with said outlet passage in the valve open position, and the two piston heads (411, 413) being of the same diameter and/or working area; and
g) characterized in that the valve chamber cylinder (203) and the spool (41) are curved.

2. A blow gun as claimed in claim 1, wherein the pivotal trigger lever (40) and the spool (41) are made as an integral unit (4).

3. A blow gun as claimed in claim 2, wherein the gun body (2) and the pivotal trigger lever (40) and the spool (41) are made from a material permitting snap mounting of the integral unit (4) in the gun body (2).

4. A blow gun as claimed in claim 3, wherein the material is a glass fiber reinforced nylon 66 resin (poly(hexamethylene adipamide)).

5. A blow gun as claimed in claim 4, wherein the valve chamber cylinder (203) and the spool (41) curve in the direction of the medium flow from the inlet passage (201) to the nozzle (30).

6. A blow gun as claimed in claim 5, wherein the direction of flow is deviated less than 90° upon passing from the inlet passage (201) into the valve chamber cylinder (203).

7. A blow gun as claimed in claim 5, wherein the direction of flow is deviated less than 90° upon passing from the valve chamber cylinder (203) into the outlet passage (211).

8. A blow gun as claimed in claim 7, wherein wherein the outlet passage (211) starts at the outlet end of the valve chamber (202), and there it has a cross section of a shape such that in the beginning of the opening movement of the spool the opening area will increase successively and that will result in a progressive flow of the high-pressure medium upon progressive movement of the spool (41) to open the valve (1) progressively.

9. A blow gun as claimed in claim 8, wherein the nozzle is a silenced blowing nozzle (30) comprising a central part (32) with at least one Laval nozzle (321) having a discharge opening (322) that will generate a concentrated core stream with supersonic velocity, and further a more peripheral part (22) surrounding the central part (32) and comprising a plurality of secondary nozzles (331) having a plurality of secondary nozzle openings (332) spaced from one another and the at least one central discharge opening (322), each secondary nozzle opening (322) generating a stream that is divergent from the axis (C) of the core stream (A).

10. A blow gun as claimed in claim 9, wherein at least some of said secondary nozzles (331) are Laval nozzles, preferably all of them.

11. A blow gun as claimed in claim 10, wherein an anti-backflow valve (5) is located in the inlet passage (201).

12. A blow gun as claimed in claim 11, wherein the anti-backflow valve (5) reduces noise caused by the pressurized medium upon entering the inlet passage (201) and minimizes an explosive noise upon disconnection of the blow gun from the pressurized medium source.

13. A blow gun as claimed in claim 11, wherein the anti-backflow valve (5) includes a generally thimble-shaped valve body (50) made of an elastic plastic material and having a plurality of laterally extending slits (501) permitting axial compression and extension of the valve body (50).

14. A blow gun as claimed in claim 13, wherein the elastic plastic material is a thermoplastic polyurethane ester resin that has a good shape memory and is resistant to oil.

15. A blow gun as claimed in claim 13, wherein the slits (501) of the valve body (50) also are shaped to serve as a filter for removing possible unwanted particles in the medium to reach and block the nozzle (30).

16. A blow gun as claimed in claim 13, wherein the valve body (50) even when fully compressed permits a full medium flow through the blow gun.

17. A blow gun as claimed in claim 6, wherein the direction of flow is deviated less than 90° upon passing from the valve chamber cylinder (203) into the outlet passage (211).

18. A blow gun as claimed in claim 1, wherein the outlet passage (211) starts at the outlet end of the valve chamber (202), and there it has a cross section of a shape such that in the beginning of the opening movement of the spool the opening area will increase successively and that will result in a progressive flow of the high-pressure medium upon progressive movement of the spool (41) to open the valve (1) progressively.

19. A blow gun as claimed in claim 1, wherein the nozzle is a silenced blowing nozzle (30) comprising a central part (32) with at least one Laval nozzle (321) having a discharge opening (322) that will generate a concentrated core stream with supersonic velocity, and further a more peripheral part (22) surrounding the central part (32) and comprising a plurality of secondary nozzles (331) having a plurality of secondary nozzle openings (332) spaced from one another and the at least one central discharge opening (322), each secondary nozzle opening (322) generating a stream that is divergent from the axis (C) of the core stream (A).

20. A blow gun as claimed in claim 1, wherein an anti-backflow valve (5) is located in the inlet passage (201).

21. A blow gun as claimed in claim 12, wherein the anti-backflow valve (5) includes a generally thimble-shaped valve body (50) made of an elastic plastic material and having a plurality of laterally extending slits (501) permitting axial compression and extension of the valve body (50).

22. A blow gun as claimed in claim 14, wherein the slits (501) of the valve body (50) also are shaped to serve as a filter for removing possible unwanted particles in the medium to reach and block the nozzle (30).

23. A blow gun as claimed in claim 14, wherein the valve body (50) even when fully compressed permits a full medium flow through the blow gun.

24. A blow gun as claimed in claim 15, wherein the valve body (50) even when fully compressed permits a full medium flow through the blow gun.
